(19) United States
(12) Patent Application Publication
(10) Pub. No.: US 2012/0273207 A1
(43) Pub. Date: Nov. 1, 2012

(54) CHITOSAN AS BIOCIDE IN OILFIELD FLUIDS

(76) Inventors: Jack Li, Sugar Land, TX (US); Philip F. Sullivan, Bellaire, TX (US); Robert Seth Hartshorne, Newmarket (GB)

(21) Appl. No.: 13/097,550

(22) Filed: Apr. 29, 2011

(51) Int. Cl. E21B 43/26; C09K 8/62; C08B 37/08

(52) U.S. Cl. 166/308.1; 536/20; 507/211

(57) ABSTRACT

The current application discloses fluids and methods for treating a subterranean formation penetrated by a wellbore, such as hydraulic fracturing. In one aspect, there is provided an oilfield fluid comprising chitosan at an amount sufficient to inhibit the growth of bacterial in the oilfield fluid. In another aspect, there is provided a method of preserving an oilfield fluid containing adding chitosan at a concentration that is sufficient to inhibit the growth of bacteria in the oilfield fluid. In a further aspect, there is provided a method of treating a subterranean formation penetrated by a wellbore, comprising preparing a treatment fluid, adding chitosan at a concentration sufficient to inhibit the growth of bacteria in the treatment fluid, introducing the mixture to the subterranean formation, and treating the subterranean formation with the mixture.

### FIELD OF THE APPLICATION

The current application is generally related to oilfield fluids and methods where chitosan is used as a biocide.

### BACKGROUND

The statements in this section merely provide background information related to the present disclosure and may not constitute prior art. All references described herein are incorporated by reference in their entireties into the current application.

Chitosan is a linear polysaccharide comprising primarily beta-(1-4)-polysaccharide of D-glucosamine. Chitosan is structurally similar to cellulose, except that the C-2 hydroxyl group in cellulose is substituted with a primary amine group in chitosan. Chitosan is produced commercially by deacetylation of chitin, which is the structural element in the exoskeleton of crustaceans such as crabs, shrimp, etc. and cell walls of fungi, etc.

Historically, the exploration of chitosan has been focused on medical and pharmaceutical applications, due to the inherent biocompatibility and reactive functionality of chitosan. Examples in these respects include using chitosan as an implantable/injectable material, a hemostatic agent, a wound-healing component, etc. The antimicrobial effect of chitosan has also been documented, mainly for applications in the medical, cosmetic, and food fields. For example, U.S. Pat. No. 6,306,835 discloses a special type of chitosan derivative that is particularly effective in controlling bacterial growth.

Much of the industrial interest in chitosan however relates to its ability to generate viscous and elastic (hydro)gels via physical or chemical interactions. For example, U.S. Pat. No. 7,007,752 discloses a method of using derivatised chitosan with an oxidized polysaccharide such as starch to form a well treatment fluid; U.S. Pat. No. 6,764,981 discloses a method of using oxidized chitosan and acrylamide-based polymer to treat a subterranean formation; U.S. Pat. No. 7,322,414 discloses a crosslinkable-polymer composition comprising an aqueous fluid, a chitosan-reacting polymer, chitosan and a gelation-retarding additive. However, these references mainly focus on the use of chitosan as an additive or crosslinker in the treatment fluid. The antimicrobial effect of the chitosan is not explored.

U.S. Pat. No. 7,256,160 discloses a fracturing fluid containing an antibacterial agent so that the fracturing fluid is capable of staying in a subterranean formation for an extended period of time, such as 28 days. The antibacterial agent disclosed therein includes a heavy metal ion such as zinc, copper, nickel or silver, which can be chelated to EDTA, complexed to chitosan and chitosan derivatives, complexed to polyols, complexed to amino acids or metalloproteins, and so on. The antibacterial/antimicrobial effect of chitosan itself is not explored.

### SUMMARY

In one aspect, the current application discloses an oilfield fluid containing chitosan at a concentration that is sufficient to inhibit the growth of bacteria in the oilfield fluid. In some embodiments, the oilfield fluid is a treatment fluid for treating a subterranean formation penetrated by a wellbore.

In another aspect, there is provided a method of preserving an oilfield fluid containing adding chitosan at a concentration that is sufficient to inhibit the growth of bacteria in the oilfield fluid.

In a further aspect, there is provided a method of treating a subterranean formation penetrated by a wellbore, comprising preparing a treatment fluid, adding chitosan at a concentration sufficient to inhibit the growth of bacteria in the treatment fluid, introducing the mixture to the subterranean formation, and treating the subterranean formation with the mixture.

In some embodiments, the fluids and methods of the current application further contain a proppant. In some embodiments, fluids and methods of the current application are used to hydraulically fracture the subterranean formation.

### DETAILED DESCRIPTION OF SOME ILLUSTRATIVE EMBODIMENTS

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

Embodiments of the current application are illustrated below in the context of an oilfield operation commonly known as hydraulic fracturing. However, it should be noted that the principles of the current application may be readily applicable to other operations in the oil and gas industry as well, such as drilling, cementing, logging, completion, production, and so on. Similarly, although embodiments of the current application are illustrated below in the context of oil and gas exploration and production, the principles of the current application can also be used in the field other than the oil and gas industry, such as construction, automobile, mining, just to name a few. With the benefit of the information disclosed herein, people skilled in the art can readily appreciate various features and advantages of the current application and make changes and modifications accordingly. All such changes and modifications should be considered within the spirit of the current application.

In the oil and gas industry, hydraulic fracturing is generally referred to as a method of using pump rate and hydraulic pressure to fracture or crack a subterranean formation. Once the crack is formed, a proppant is pumped into the fracture to prop open the crack and maintain the crack in the opened position after the hydraulic pressure is reduced or removed. Therefore, a high permeability pathway can be formed between the wellbore and a large radius of formation and the production of hydrocarbons can be increased.

Most commercially used fracturing fluids are aqueous liquids, although non-aqueous fracturing fluids such as hydrocarbon-based liquids have also been developed and used in the oilfield. Therefore, the carrying medium in a fracturing fluid can be either aqueous or non-aqueous. Examples of aqueous carrying medium include, but are not limited to, freshwater, seawater, saltwater, brines (e.g. natural brines, formulated brines, saturated brines, unsaturated brines, etc.) or a mixture thereof. Examples of non-aqueous carrying medium include, but are not limited to, diesel, kerosene, alcohol, crude oil, or a mixture thereof. The carrying medium may be supplied from any source available at the wellsite, such as tanks, vehicles, vessels, or pipelines.

According to one aspect of the current application, there is provided an oilfield fluid containing chitosan at a concentration that is sufficient to inhibit the growth of bacteria in the oilfield fluid. As used herein, the term “oilfield fluid” is to be construed broadly, which may include any substance that is used in the oil and gas industry, especially during an oilfield operation such as drilling, logging, cementing, stimulating (including hydraulic fracturing and acidizing), completing and producing, which has no fixed shape, yields easily to external pressure, and has the tendency to assume the shape of its container. Examples include, but are not limited, a gas, a liquid, a solution, a foam, an emulsion, a suspension, a colloid, a slurry, and so on. In some embodiments, the oilfield fluid is a treatment fluid for treating a subterranean formation penetrated by a wellbore.

As used herein, the term “chitosan” is to be construed broadly, which may include unoxidized chitosan, oxidized chitosan, unmodified chitosan, modified chitosan, or mixtures thereof. Also, as used herein, the term “chitosan” is intended to include both the chitosan and chitosan salts of mineral or organic acids. Most commercially available chitosan is a partially or fully deacetylated form of chitin, which is a naturally occurring polysaccharide found in crustaceans (e.g. crabs, lobsters and shrimps) and other sources. The chitosan may have a degree of deacetylation that is in the range of from about 50% to about 100%. In certain embodiments, the chitosan may have a degree of deacetylation that is in the range of from about 70% to 78%.

In some embodiments, the chitosan used in the current application is unoxidized and unmodified. In some embodiments, the chitosan used in the current application is oxidized but unmodified. In some embodiments, the chitosan is used in the current application unoxidized but modified. In some embodiments, the chitosan used in the current application is oxidized and modified. All such and other variations are within the scope of the current application.

With respect to oxidization, suitable chitosan-based compounds that may be oxidized include, but are not limited to, chitosan and chitosan salts of mineral or organic acids. A wide variety of oxidizers may be used to oxidize the chitosan. Examples of suitable oxidizers include, but are not limited to sodium hypochlorite, sodium chlorite, sodium persulfate, sodium periodate, hydrogen peroxide, organic peroxides, peracetic acid, and mixtures thereof.

With respect to modification, the term, “modified chitosan,” as used herein, refers to chitosan grafted with additional functional groups, including, but not limited to, carboxymethyl groups, hydroxyethyl groups, hydroxypropyl groups, or combinations thereof. Other functional group modifications may be suitable as recognized by one skilled in the art with the benefit of this disclosure.

The chitosan is added to the oilfield fluid of the current application in an amount sufficient to inhibit the growth of one or more bacteria commonly found in the oilfield. One example of such bacteria is the sulfate-reducing bacteria. In certain embodiments, the chitosan may be present in the oilfield fluid in an amount of from about 1 ppt to about 10,000 ppt. In certain other embodiments, the chitosan may be present in the oilfield fluid in an amount of from about 5 ppt to about 1,000 ppt. In certain additional embodiments, the chitosan may be present in the oilfield fluid in an amount of from about 10 to about 100 ppt. In certain specific embodiments, the chitosan may be present in the fluid in an amount of about 30 ppt.

In one aspect, the oilfield fluid containing chitosan at a concentration sufficient to inhibit the growth of bacterial may exhibit a reduced amount of bacterial growth compared with a solution containing no or insufficient amount chitosan.

In another aspect, the oilfield fluid containing chitosan at a concentration sufficient to inhibit the growth of bacterial may exhibit a prolonged period of viable life compared with a solution containing no or insufficient amount chitosan. In certain embodiments, the viable life of the oilfield fluid containing sufficient amount of chitosan as an antimicrobial agent exhibits a viable life of at least 15 days after preparation. In certain other embodiments, the viable life of the oilfield fluid containing sufficient amount of chitosan as an antimicrobial agent exhibits a viable life of at least 30 days after preparation. In certain further embodiments, the viable life of the oilfield fluid containing sufficient amount of chitosan as an antimicrobial agent exhibits a viable life of at least 45 days after preparation.

As used herein, the term “viable life” of an oilfield fluid means that the oilfield fluid is in a stable condition after preparation and can be readily applied to a subterranean formation to perform a desired oilfield operation. In some embodiments, the oilfield operation is a hydraulic fracturing operation and the oilfield fluid is a hydraulic fracturing fluid. One of the major characteristics that need to be monitored is the viscosity of the hydraulic fracturing fluid. Accordingly, in such embodiments, the term “viable life” may refer to a condition that the viscosity of the oilfield fluid does not decrease for more than 20% over the prolonged period of time.

To facilitate the dissolution of the chitosan, the chitosan can be pre-dissolved in an acidic carrying medium to form a chitosan solution. In certain embodiments, the pH value of the chitosan solution may be in a range from about 2 to about 6.5. In certain other embodiments, the pH value of the fluid may be in a range from about 3 to about 6. In certain additional embodiments, the pH value of the fluid may be in a range from about 4.5 to about 5.7.

For a better understanding of the present invention, the following example of certain aspects of some embodiments is given. In no way should the following example be read to limit, or define, the scope of the invention.

### EXAMPLE

Titanate solution was prepared by dissolving triethanolamine titanate (CAS No. 36673-16-2) in suitable amount of propan-2-ol and acetic acid so that a light yellow colored solution was obtained. After preparation, each gallon of the titanate solution contained approximately 40 wt % triethanolamine titanate. The relative density of the solution to water was 1.1 at 25° C.

The fracturing fluid was prepared by mixing 30 ppt of guar (CAS No. 9000-30-0), 2 wt % of KCl, and 2.25 gpt (gallon per thousand gallon) of the titanate solution in tap water.

Two samples of the fracturing fluid were obtained and kept in 205 ml glass jars with cover. Chitosan (Sigma-Aldrich Product No. 419419) was added at 0.36% or 30 ppt to one sample, but not the other. Both samples were kept on the laboratory bench under room temperature (approximately 68° F.) and observed daily for 45 days. No obvious physical change was observed after 11 days after preparation. However, 45 days after preparation, the fluid containing no chitosan formed a transparent aqueous fluid with a layer of polymer residue and some black spots, indicating that bacteria had grown in this fluid sample. On the other hand, no obvious viscosity change was observed in the fluid sample containing 30 ppt chitosan, indicating that chitosan had successfully inhibited the bacterial growth and maintained the fluid integrity and viscosity.

The preceding description has been presented with reference to some illustrative embodiments of the Inventors' concept. Persons skilled in the art and technology to which this invention pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

Furthermore, none of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle. The claims as filed are intended to be as comprehensive as possible, and NO subject matter is intentionally relinquished, dedicated, or abandoned.

We claim:

1. An oilfield fluid comprising chitosan at a concentration that is sufficient to inhibit the growth of bacteria in the oilfield fluid.

2. The oilfield fluid of claim 1, wherein the oilfield fluid is a hydraulic fracturing fluid.

3. The oilfield fluid of claim 1, wherein the chitosan is unoxidized chitosan, oxidized chitosan, unmodified chitosan, modified chitosan, or mixtures thereof.

4. The oilfield fluid of claim 1, wherein the chitosan is unoxidized and unmodified chitosan.

5. The oilfield fluid of claim 1, wherein the chitosan is present in the oilfield fluid in an amount of from about 1 ppt to about 10,000 ppt.

6. The oilfield fluid of claim 5, wherein the chitosan is present in the oilfield fluid in an amount of from about 5 ppt to about 1,000 ppt.

7. The oilfield fluid of claim 1, wherein the chitosan is present in the oilfield fluid in an amount of from about 10 ppt to about 100 ppt.

8. The oilfield fluid of claim 1, wherein the chitosan is present in the oilfield fluid in an amount of about 30 ppt.

9. A method of preserving an oilfield fluid, said method comprising:
adding chitosan to the oilfield fluid at a concentration that is sufficient to inhibit bacterial growth in the oilfield fluid.

10. The method of claim 9, wherein said inhibiting bacterial growth is manifested by maintaining a viable life of the oilfield fluid for at least 15 days after preparation.

11. The method of claim 10, wherein said inhibiting bacterial growth is manifested by maintaining a viable life of the oilfield fluid for at least 30 days after preparation.

12. The method of claim 11, wherein said inhibiting bacterial growth is manifested by maintaining a viable life of the oilfield fluid for at least 45 days after preparation.

13. The method of claim 10, wherein said viable life of the oilfield fluid means a viscosity of the oilfield fluid does not decrease for more than 20% from preparation to usage.

14. A method of treating a subterranean formation penetrated by a wellbore, said method comprising:
preparing a treatment fluid;
adding chitosan to the treatment fluid at a concentration sufficient to inhibit bacterial growth in the treatment fluid;
introducing the treatment fluid containing chitosan to the subterranean formation; and
treating the subterranean formation with the treatment fluid containing chitosan.

15. The method of claim 14, wherein the treatment fluid is a hydraulic fracturing fluid.

16. The method of claim 15, wherein the hydraulic fracturing fluid further comprises a proppant.

17. The method of claim 14, further comprising, after adding chitosan to the treatment fluid and before introducing the treatment fluid containing chitosan to the subterranean formation:
maintaining a viable life of the oilfield fluid for at least 15 days.

18. The method of claim 17, further comprising, after adding chitosan to the treatment fluid and before introducing the treatment fluid containing chitosan to the subterranean formation:
maintaining a viable life of the oilfield fluid for at least 30 days.

19. The method of claim 17, further comprising, after adding chitosan to the treatment fluid and before introducing the treatment fluid containing chitosan to the subterranean formation:
maintaining a viable life of the oilfield fluid for at least 45 days.

20. The method of claim 17, wherein said viable life of the oilfield fluid means a viscosity of the oilfield fluid does not decrease for more than 20% from preparation to usage.
